(19) United States
(12) Patent Application Publication
(10) Pub. No.: US 2015/0045028 A1
(43) Pub. Date: Feb. 12, 2015

(54) USER EQUIPMENT SPECIFIC MOBILITY OPTIMIZATION AND IMPROVED PERFORMANCE METRICS FOR IMPROVING HANDOVER PERFORMANCE

(71) Applicant: QUALCOMM Incorporated, San Diego, CA (US)

(72) Inventors: Damanjit Singh, San Diego, CA (US); Rajat Prakash, San Diego, CA (US); Chirag Sureshbhai Patel, San Diego, CA (US)

(73) Assignee: QUALCOMM INCORPORATED, San Diego, CA (US)

(21) Appl. No.: 14/275,611

(22) Filed: May 12, 2014

Related U.S. Application Data
(60) Provisional application No. 61/864,427, filed on Aug. 9, 2013.

(51) Int. Cl. H04W 36/00

(52) U.S. Cl. CPC H04W 36/0094
USPC 455/436

(57) ABSTRACT

A system for optimizing mobility robustness is operable by a network entity that detects handovers or connection failures by served access terminals. The network entity defines classifications based on mobility, route, past serving cell, or location information for the served access terminals and associates each of the handovers or connection failures with a related classification. A system for improving handover performance records a time for which an access terminal is served by the network entity before being served by a neighboring cell. A performance metric is determined based on the recorded time and a handover policy is optimized based on the performance metric.

### CROSS-REFERENCE TO RELATED APPLICATIONS

This application claims the benefit of U.S. Provisional Patent Application Ser. No. 61/864,427 entitled “UE-SPECIFIC MOBILITY OPTIMIZATION AND RECORDING TIME SERVED FOR IMPROVING HANDOVER PERFORMANCE”, which was filed Aug. 9, 2013. The aforementioned application is herein incorporated by reference in its entirety.

### BACKGROUND

Aspects of the present disclosure relate generally to wireless communication systems, and more particularly to mobility optimization and handover performance of mobile devices.

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices (e.g., which can be commonly referred to as mobile phones, tablet computers, or mobile computers, collectively referred to as access terminals (AT), user equipment (UE), etc.). Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

To supplement conventional base stations, additional small cells can be deployed to provide more robust wireless coverage to mobile devices. Small cells are low power base stations which transmit at a lower power than macro cells and have smaller coverage than macro cells. For example, small cells (e.g., which can be commonly referred to as Home NodeBs or Home eNBs, collectively referred to as H(e)NBs, small cells, small cell nodes, microcell nodes, small cell access points, femtocells, femtocell nodes, femtocell access points, pico nodes, micro nodes, low power base stations, etc.) can be deployed for incremental capacity growth, richer user experience, in-building or other specific geographic coverage, and/or the like. In some configurations, such small cells are connected to the Internet via broadband connection (e.g., digital subscriber line (DSL) router, cable or other modem, etc.), which can provide the backhaul link to the mobile operator's network. In this regard, small cells are often deployed in homes, offices, etc. without consideration of a current network environment.

A connected-mode UE moves from one cell to another via handovers. However, certain situations of UE movement between neighboring cells result in a connection failure. Optimizing handover policies for the neighboring cells can prevent many of the connection failures. Mobility robustness optimization (MRO) defined in 3GPP (TS 36.300) may include detecting and enabling correction of connection failures due to intra-LTE mobility. MRO identifies connection failures as “too late handover”, “too early handover” and “handover to wrong cell”.

MRO is defined to operate at a cell level and detect and identify connection failures at a cell for all users. Users of different UEs with different movements and locations may experience different radio frequency conditions and therefore different causes of connection failures. This one-size-fits-all approach limits the ability of MRO to correct failures. Therefore, there is a need for an improved method of MRO.

To further improve handover performance, it is helpful to measure and evaluate various performance metrics. A number of connection failures per unit time, such as for example, per minute, may be calculated by a number of connection failures in a total time a cell is turned on. However, this performance metric may not provide an accurate description of user-experience of UEs at that cell. For example, if a cell is turned on for a long total time but serving only few users, then the number of connections failure per unit time value may be very small, even in a situation where most of the connections resulted in connection failures. Therefore, there is a need for a new way of evaluating performance metrics for monitoring and evaluating handover performance experienced by UEs.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In accordance with one or more aspects of the implementations described herein, there is provided a system and method for optimizing mobility robustness. In one implementation, a network entity may detect at least one handover or connection failure by at least one served access terminal. The network entity may define a plurality of classifications based at least in part on at least one of mobility, route, past serving cell, or location information for the at least one served access terminal and associate each of the at least one handover or connection failure with a related classification from the plurality of classifications.

In a second implementation, a network entity may record a time for which an access terminal is served by the network entity before being served by a neighboring cell. The network entity may determine a performance metric for handing over to the neighboring cell based at least in part on the recorded time and optimize a handover policy for handing over to the neighboring cell based at least in part on the performance metric.

### BRIEF DESCRIPTION OF THE DRAWINGS

FIG. 1 is an illustration of an example wireless communication network.

FIG. 2 is a block diagram illustrating an example of communication system components.

FIG. 3 illustrates an example handover scenario between access points.

FIG. 4 is a block diagram illustrating an example of a communication system for optimizing mobility robustness.

FIG. 5 is a flow diagram illustrating an example of updating handover policy.

FIG. 6 is a block diagram illustrating an example of a communication system for improving handover performance.

FIG. 7 illustrates an example of a methodology for optimizing mobility robustness.

FIG. 8 illustrates optional operations in accordance with the methodology of FIG. 7.

FIG. 9 shows an implementation of an apparatus in accordance with the methodology of FIG. 7.

FIG. 10 illustrates aspects of an example methodology for improving handover performance.

FIG. 11 shows an implementation of an apparatus in accordance with the methodology of FIG. 10.

### DETAILED DESCRIPTION

A UE served by an access point may move away from the access point towards a neighboring access point. A handover procedure may change service for the UE to the neighboring access point. Optimization of handovers typically includes a trade-off between unnecessary or early handovers and delayed handovers. Handovers that are unnecessary may cause increased signal load at the network, packet delays, voice artifacts, and worse user experience. Handovers that are too early may cause connection failures. Handovers that are too late or delayed may cause users to lose coverage and cause call drops or connection failures. Too late handovers may also cause the UE to be served by a non-best access point for a long time. Moreover, handovers that are too late may also cause greater signaling load, larger packet delays, and worse user experience. In certain cases, movement of UEs may cause a radio link failure or connection failure.

Optimizing handover policies may prevent many of these connection failures. However, different UEs may be located in different locations and may have different movement patterns. The different UEs may experience different radio frequency conditions and experience different causes of connection failures. Handover policies optimized broadly for all UEs on a particular cell may not be ideal for each individual UE. More effective handover policy optimizations may be implemented by defining categories for the UEs and collecting data on handover and connection failures associated with each of the categories. Different handover policies may then optimized for each of the categories.

Techniques for supporting radio communication are described herein. The techniques may be used for various wireless communication networks such as wireless wide area networks (WWANs) and wireless local area networks (WLANs). The terms “network” and “system” are often used interchangeably. The WWANs may be CDMA, TDMA, FDMA, OFDMA, SC-FDMA and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

The techniques described herein may be used for the wireless networks and radio technologies mentioned above as well as other wireless networks and radio technologies. For clarity, certain aspects of the techniques are described below for 3GPP network and WLAN, and LTE and WLAN terminology is used in much of the description below. The word “exemplary” to the extent used herein means “serving as an example, instance, or illustration.” Any implementation described herein as “exemplary” is not necessarily to be construed as preferred or advantageous over other implementations.

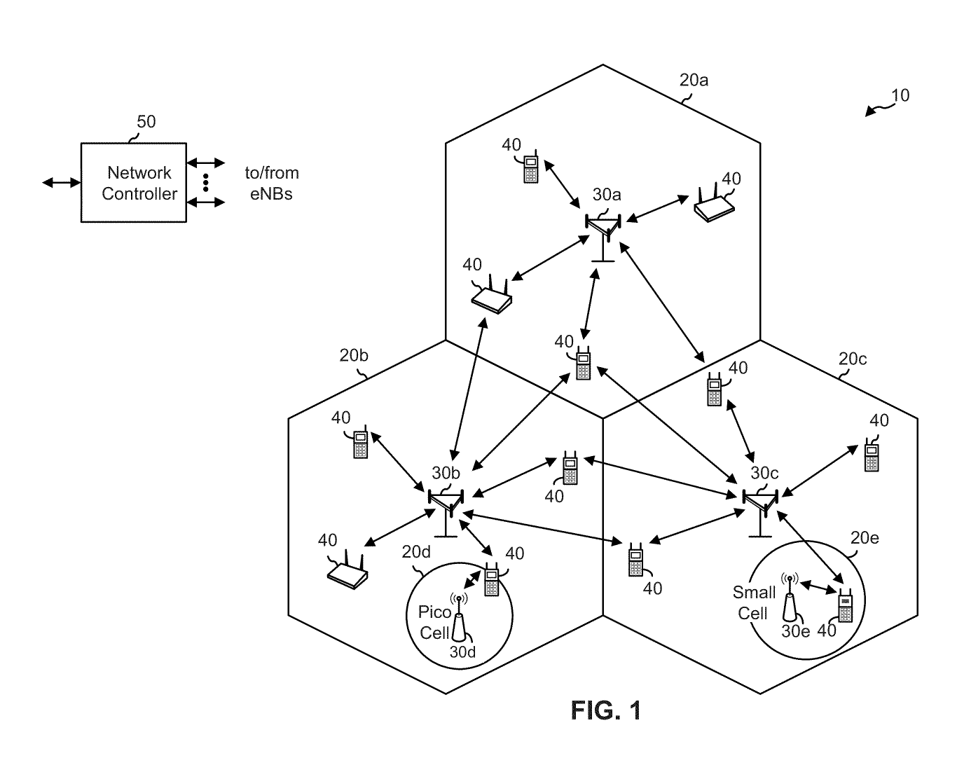

FIG. 1 is an illustration of an example wireless communication network 10, which may be an LTE network or some other wireless network. Wireless network 10 may include a number of evolved Node Bs (eNBs) 30 and other network entities. An eNB may be an entity that communicates with mobile entities (e.g., user equipment (UE), access terminals, etc.) and may also be referred to as a base station, a Node B, an access point, etc. Although the eNB typically has more functionalities than a base station, the terms “eNB” and “base station” are used interchangeably herein. Each eNB 30 may provide communication coverage for a particular geographic area and may support communication for mobile entities located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macrocell, a picocell, a microcell, a small cell, and/or other types of cell. A macrocell may cover a relatively large geographic area (e.g., several kilometers in radius) and may allow unrestricted access by UEs with service subscription. A picocell may cover a relatively small geographic area and may allow unrestricted access by UEs with service subscription. A small cell may cover a relatively small geographic area (e.g., a home) and may allow restricted access by UEs having association with the small cell (e.g., UEs in a Closed Subscriber Group (CSG)). In the example shown in FIG. 1, eNBs 30a, 30b, and 30c may be macro eNBs for macrocell groups 20a, 20b, and 20c, respectively. Each of the cell groups 20a, 20b, and 20c may include a plurality (e.g., three) of cells or sectors. An eNB 30d may be a pico eNB for a picocell 20d. An eNB 30e may be a small cell eNB, small cell base station, or small cell access point (FAP) for a small cell 20e.

Wireless network 10 may also include relays (not shown in FIG. 1). A relay may be an entity that can receive a transmission of data from an upstream station (e.g., an eNB or a UE) and send a transmission of the data to a downstream station (e.g., a UE or an eNB). A relay may also be a UE that can relay transmissions for other UEs.

A network controller 50 may couple to a set of eNBs and may provide coordination and control for these eNBs. Network controller 50 may be a single network entity or a collection of network entities. Network controller 50 may communicate with the eNBs via a backhaul. The eNBs may also communicate with one another, e.g., directly or indirectly via a wireless or wireline backhaul.

UEs 40 may be dispersed throughout wireless network 10, and each UE may be stationary or mobile. A UE may also be referred to as a user device, a mobile device, a mobile station, a terminal, an access terminal, a subscriber unit, a station, or other terminology. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with eNBs, relays, or other terminology. A UE may also be able to communicate peer-to-peer (P2P) with other UEs.

Wireless network 10 may support operation on a single carrier or multiple carriers for each of the downlink (DL) and uplink (UL). A carrier may refer to a range of frequencies used for communication and may be associated with certain characteristics. Operation on multiple carriers may also be referred to as multi-carrier operation or carrier aggregation. A UE may operate on one or more carriers for the DL (or DL carriers) and one or more carriers for the UL (or UL carriers) for communication with an eNB. The eNB may send data and control information on one or more DL carriers to the UE. The UE may send data and control information on one or more UL carriers to the eNB. In one design, the DL carriers may be paired with the UL carriers. In this design, control information to support data transmission on a given DL carrier may be sent on that DL carrier and an associated UL carrier. Similarly, control information to support data transmission on a given UL carrier may be sent on that UL carrier and an associated DL carrier. In another design, cross-carrier control may be supported. In this design, control information to support data transmission on a given DL carrier may be sent on another DL carrier (e.g., a base carrier) instead of the DL carrier.

Wireless network 10 may support carrier extension for a given carrier. For carrier extension, different system bandwidths may be supported for different UEs on a carrier. For example, the wireless network may support (i) a first system bandwidth on a DL carrier for first UEs (e.g., UEs supporting LTE Release 8 or 9 or some other release) and (ii) a second system bandwidth on the DL carrier for second UEs (e.g., UEs supporting a later LTE release). The second system bandwidth may completely or partially overlap the first system bandwidth. For example, the second system bandwidth may include the first system bandwidth and additional bandwidth at one or both ends of the first system bandwidth. The additional system bandwidth may be used to send data and possibly control information to the second UEs.

Wireless network 10 may support data transmission via single-input single-output (SISO), single-input multiple-output (SIMO), multiple-input single-output (MISO), and/or multiple-input multiple-output (MIMO). For MIMO, a transmitter (e.g., an eNB) may transmit data from multiple transmit antennas to multiple receive antennas at a receiver (e.g., a UE). MIMO may be used to improve reliability (e.g., by transmitting the same data from different antennas) and/or to improve throughput (e.g., by transmitting different data from different antennas).

Wireless network 10 may support single-user (SU) MIMO, multi-user (MU) MIMO, Coordinated Multi-Point (CoMP), etc. For SU-MIMO, a cell may transmit multiple data streams to a single UE on a given time-frequency resource with or without precoding. For MU-MIMO, a cell may transmit multiple data streams to multiple UEs (e.g., one data stream to each UE) on the same time-frequency resource with or without precoding. CoMP may include cooperative transmission and/or joint processing. For cooperative transmission, multiple cells may transmit one or more data streams to a single UE on a given time-frequency resource such that the data transmission is steered toward the intended UE and/or away from one or more interfered UEs. For joint processing, multiple cells may transmit multiple data streams to multiple UEs (e.g., one data stream to each UE) on the same time-frequency resource with or without precoding.

Wireless network 10 may support hybrid automatic retransmission (HARQ) in order to improve reliability of data transmission. For HARQ, a transmitter (e.g., an eNB) may send a transmission of a data packet (or transport block) and may send one or more additional transmissions, if needed, until the packet is decoded correctly by a receiver (e.g., a UE), or the maximum number of transmissions has been sent, or some other termination condition is encountered. The transmitter may thus send a variable number of transmissions of the packet.

Wireless network 10 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 10 may utilize frequency division duplex (FDD) or time division duplex (TDD). For FDD, the DL and UL may be allocated separate frequency channels, and DL transmissions and UL transmissions may be sent concurrently on the two frequency channels. For TDD, the DL and UL may share the same frequency channel, and DL and UL transmissions may be sent on the same frequency channel in different time periods.

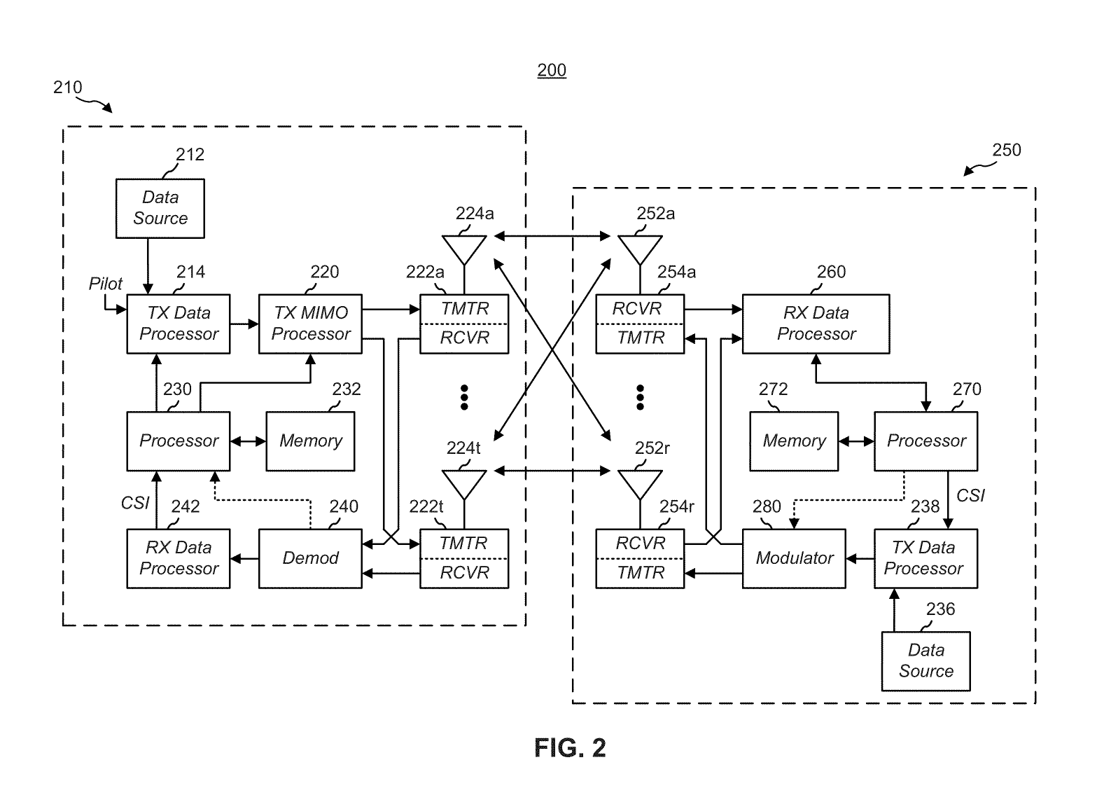

FIG. 2 illustrates a system 200 including a transmitter system 210 (also known as the access point, base station, or eNB) and a receiver system 250 (also known as access terminal, mobile device, or UE) in an LTE MIMO system 200. In the present disclosure, the transmitter system 210 may correspond to a WS-enabled eNB or the like, whereas the receiver system 250 may correspond to a WS-enabled UE or the like.

At the transmitter system 210, traffic data for a number of data streams is provided from a data source 212 to a transmit (TX) data processor 214. Each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain implementations, TX MIMO processor 220 applies beam-forming weights to the symbols of the data streams and to the antenna from which the symbol is being transmitted.

Each transmitter 222 receives and processes a respective symbol stream to provide one or more analog signals, and further conditions (e.g., amplifies, filters, and up-converts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and down-converts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, de-interleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beam-forming weights then processes the extracted message.

As used herein, an access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macrocell, a macro node, a Home eNB (HeNB), a microcell, a microcell node, a femtocell, a small cell node, a pico node, or some other similar terminology.

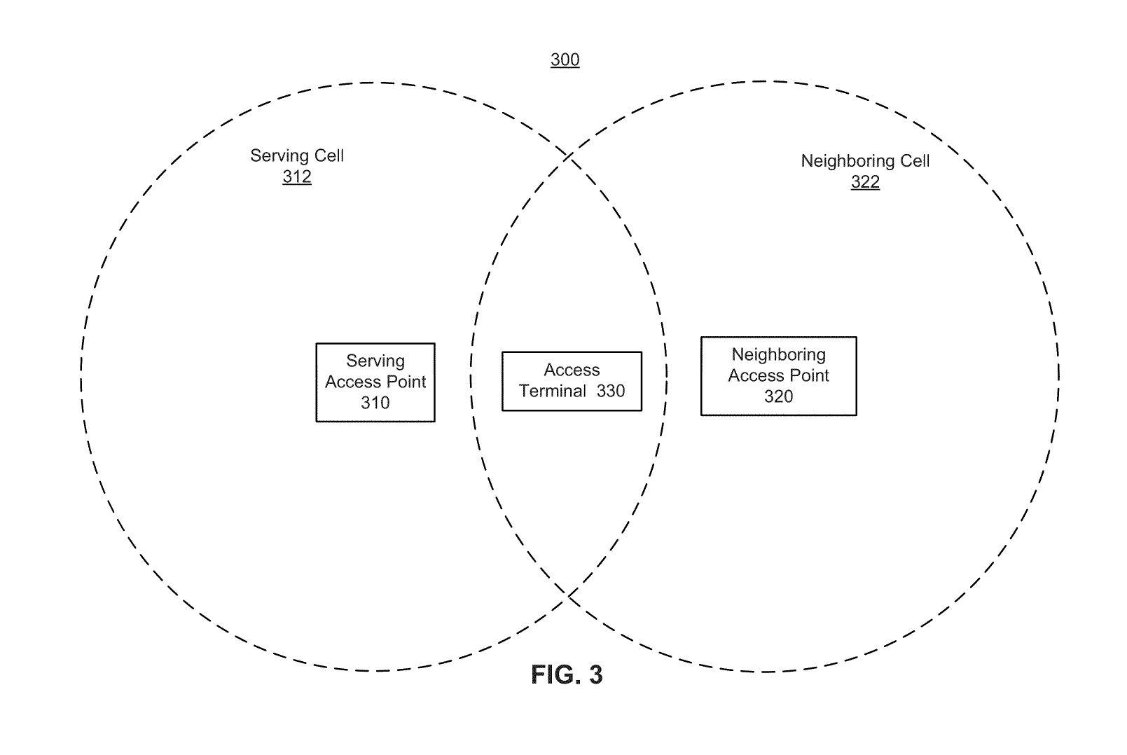

FIG. 3 illustrates an example handover scenario between two access points. For illustration purposes, various aspects of the disclosure will be described in the context of one or more access terminals, access points, and network entities that communicate with one another. It should be appreciated, however, that the teachings herein may be applicable to other types of apparatus or other similar apparatus that are referenced using other terminology.

Access points 310 and 320 in the system 300 may provide access to one or more services (e.g., network connectivity) for one or more wireless terminals (e.g., access terminal, UE, mobile entity, mobile device) 330 that may be installed within or that may roam throughout a coverage area of the system 300. For example, at various points in time, the access terminal 330 may connect to a serving access point 310, a neighboring point 320, or another access point (not shown) in the system 300. Each of the access points 310 and 320 may communicate with one or more network entities to facilitate wide area network connectivity. Such network entities may take various forms such as, for example, one or more radio and/or core network entities.

In various implementations, the network entities may be responsible for or otherwise be involved with handling: network management (e.g., via an operation, administration, management, and provisioning entity), call control, session management, mobility management, gateway functions, interworking functions, or some other suitable network functionality. In a related aspect, mobility management may relate to or involve: keeping track of the current location of access terminals through the use of tracking areas, location areas, routing areas, or some other suitable technique; controlling paging for access terminals; and providing access control for access terminals. Also, two or more of these network entities may be co-located and/or two or more of such network entities may be distributed throughout a network.

The UE 330 served by the serving access point 310 may move to another cell served by another access point via a handover. The serving access point 310 may configure the UE 330 served by the serving access point 310 with a handover policy. The handover policy may, for example, include a set of parameters (e.g., handover parameters) for an event (e.g., Event A3 in LTE) that is reported by the UE 330 and, which may cause serving access point 310 to trigger handover of the UE 330 to the neighboring access point 320. For example, the set of parameters may include an offset parameter that defines an amount by which a signal quality of the neighboring access point 320 is better than a signal quality of the serving access point 310. Other examples of offsets in UMTS and LTE may include hysteresis, event offset, cell individual offset, reporting range, and frequency offset. Another example of a parameter is a time-to-trigger parameter that defines a minimum duration for which certain conditions must be satisfied for an event to be triggered. In an example implementation, the UE 330 may be configured to report to the serving access point if and when the handover policy is satisfied. For example, when the handover policy is satisfied, the serving access point 310 may determine to whether to initiate handover of the UE 330 to the neighboring point 320.

A handover typically provides a trade-off between unnecessary or early handovers and delayed handovers. Unnecessary or early handovers may occur due to channel fading or random user mobility, where the channel conditions change only temporarily and a handover is not necessary. Handovers that are too early may cause increased signal load at the network, packet delays, voice artifacts, and worse user experience. Handovers that are too late may cause users to lose coverage and cause call drops as the UE continues to be served by a non-best access point. Handovers that are too late may also cause greater signaling load, larger packet delays, and worse user experience. In certain cases, movement of UEs may cause a radio link failure or connection failure. 3GPP describes a mobility robustness optimization (MRO) feature which defines connection failures as “too late handover”, “too early handover”, and “handover to wrong cell”.

Handovers that are too late are connection failures that occur at the serving cell before a handover was initiated or during the handover. A UE then attempts to re-establish a radio link connection at the neighboring cell. In one scenario, this may occur if the UE is moving more quickly than what the handover policy allows for. Handovers that are too early are connection failures that occur shortly after a successful handover to the neighboring cell from the serving cell, where the UE then attempts to re-establish a radio link connection with the serving cell. In one scenario, this may occur when the UE enters and quickly exits a small or island coverage area of the neighboring cell. Handovers to a wrong cell are connection failures that occur shortly after a successful handover from the serving cell to the neighboring cell, where the UE then attempts to re-establish a radio link connection to a third cell.

Connection failures are determined at a cell and can be used to reduce future connection failures at the cell. Some connection failures resulting from handing over to a particular neighboring cell may be corrected by adjusting the cell's handover policy for that particular neighboring cell. For example, if the access terminal 330 hands over from the serving access point 310 to the neighboring access point 320 too late, the handover policy may be adjusted to allow for an earlier handover.

The MRO feature described by 3GPP operates at a cell level by detecting and identifying connection failures at the serving cell for all served UEs. Individual UE mobility, route, past serving cell, and location characteristics are not considered, even though each UE may move in different speeds, take different routes, be served by different past cells, and are located in different areas. Each UE may experience different radio frequency conditions which provide different causes of connection failures. For example, a fast moving UE may experience handovers that are too late while a slow moving UE may not experience such connection failures. MRO may therefore be improved by taking into account mobility, route, past serving cell, and location characterizes of individual UEs for handover policies.

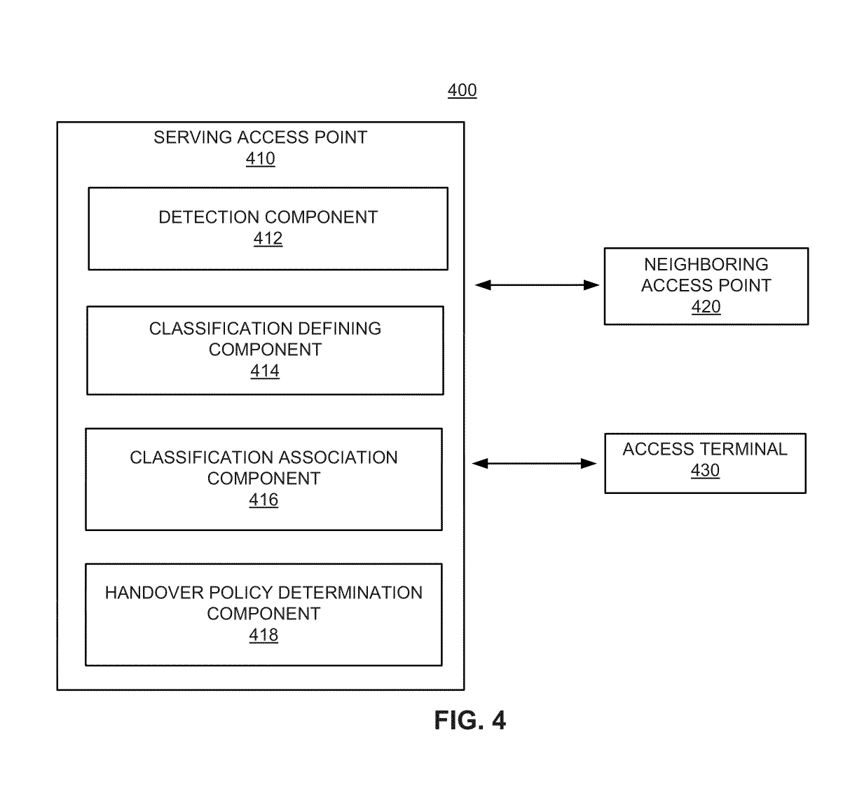

FIG. 4 is a block diagram illustrating an example of a communication system for optimizing mobility robustness. In accordance with an example implementation of a communication system 400, a serving access point 410 (e.g., microcell base station, small cell base station) provides service to an access terminal 430. In a related implementation, the access terminal 430 may attempt to handover to a neighboring access point 420.

The serving access point 410 may include a detection component 412 to detect handovers or connection failures by at least one served access terminal. For example, the detection component 412 may comprise a processor that detects access terminals disconnecting from the serving access point 410. In one implementation, the detection component 412 may identify a handover or connection failure type in response to the access terminal 410 leaving service from the serving access point 410. The detection component 412 may identify the handover or connection failure type as one of a “normal handover”, a “too early handover”, a “too late handover”; or a “handover to wrong cell”.

The serving access point 410 may include a classification defining component 414 to define a plurality of classifications based at least in part on at least one of mobility, route, past serving cells, or location information for the at least one served access terminal 430. In one implementation, the classification defining component 414 may comprise a processor that creates and stores the plurality of classifications in a storage medium such as memory. For example, classifications may be defined based on velocities of access terminals (e.g., slow moving or fast moving access terminals), based on routes of movement (e.g., a particular series of cells an access terminal was previously served by), based on particular locations within the serving cell (e.g., based on estimated path loss or reported signal strength measurements of access terminals), or based on particular mobility patterns (e.g., based on whether access terminals are ping-ponging between cells, suggested by cell changes where at least one cell identity is repeated in a given number of cell changes). In a related aspect, the serving access point 410 may count a number of normal handovers, handovers that are too early, handovers that are too late, and handovers to a wrong cell, for each defined classification.

In an example implementation, the classification defining component 414 may obtain a UE History Information information element (IE), as defined by 3 GPP, for each of the at least one served access terminal and determine the at least one of mobility, route, past serving cells, or location information based at least in part on the UE history information IE. The UE history information IE may include at least one of a record of identities of past serving cells, a record of time that a UE stayed in each of the past serving cells, or a handover cause value. In a related aspect, the serving access point 410 may receive an updated UE history information IE from the neighboring access point 420. In another related aspect, the serving access point 410 may update and send the UE history information IE for use by the neighboring access point 420.

The serving access point 410 may include a classification association component 416. In one implementation, the classification association component 416 may comprise a processor that associates and stores in a memory each of the at least one handover or connection failure with a related classification from the plurality of classifications. For example, the classification association component 416 may associate a handover that is too early by a fast moving UE with a related classification for fast moving UEs.

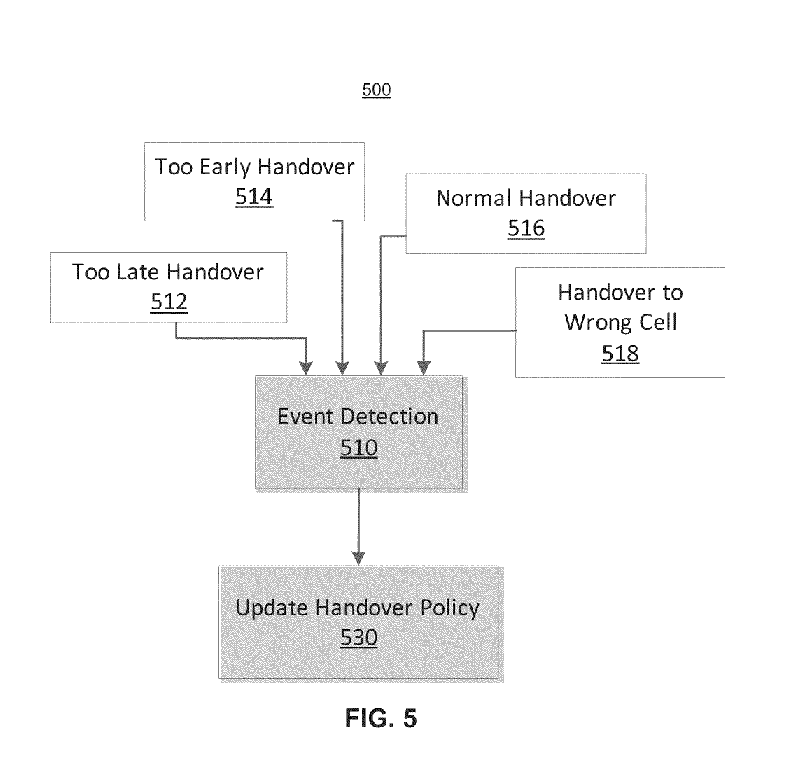

The serving access point 410 may include a handover policy determination component 418 to determine a handover policy for the related classification, for at least one neighboring cell, based at least in part on the at least one handover or connection failure. In an example implementation, the handover policy may include determining an optimized set of handover parameters based at least in part on the at least one handover or connection failure. The handover policy determination component 418 may update the handover policy with the optimized set of handover parameters. In a related aspect, the set of handover parameters includes a parameter for comparing of the serving cell signal quality with a neighboring cell signal quality. In another related aspect, the set of handover parameters includes a hysteresis parameter, a time-to-trigger (TTT) parameter, or a filter coefficient. In yet another related aspect, the set of handover parameters includes at least one of an event offset parameter, a cell individual offset (CIO) parameter, a reporting range parameter, or a frequency offset parameter. In an example implementation, the serving access point may apply the handover policy to the served access terminal 430. FIG. 5 is a flow diagram illustrating an example of updating handover policy. When a UE leaves a serving cell, the event detection 510 may detect one of a “too late handover” 512, a “too early handover” 514, a “normal handover” 516, or a “handover to wrong cell” 518. This detected information may then be used to update handover policy 530 for a related classification. For example, the detected handover or connection failure may be used as a new data point in optimizing the handover policy for the related classification.

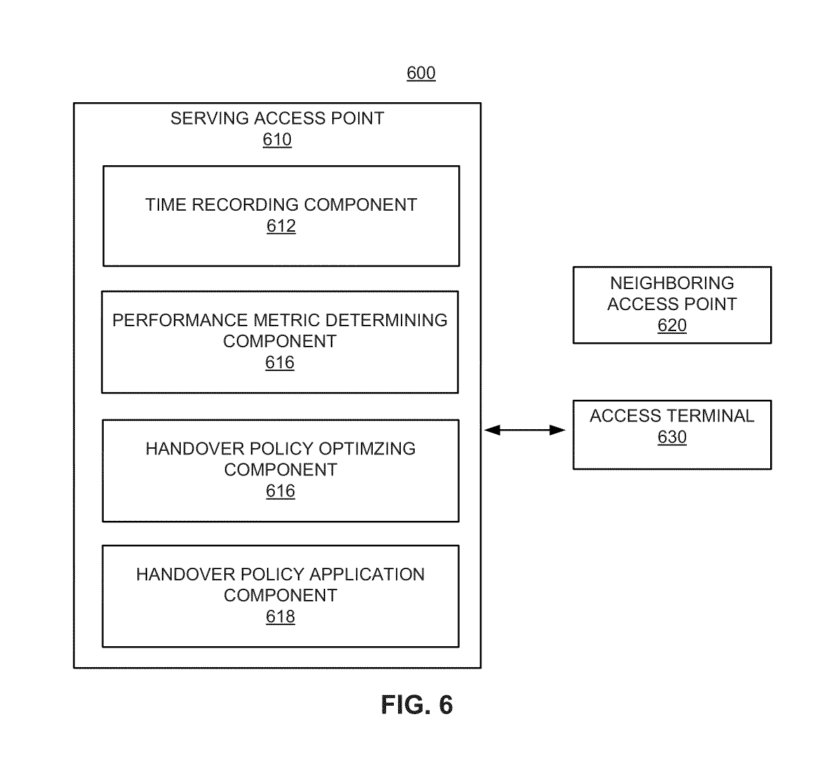

FIG. 6 is a block diagram illustrating an example of a communication system for improving handover performance. The serving access point 610 may include a time recording component 612 for recording a time for which an access terminal 630 is served by the network entity before being served by a neighboring cell 620. The recorded time may be based on an amount of time the access terminal 630 is served by the serving access point 610 before a handover or a connection failure occurs.

The serving access point 610 may include a performance metric determining component 618 for determining a performance metric for handing over to the neighboring cell based at least in part on the recorded time. In an example implementation, the performance metric includes a count of handover or connection failures per unit time (e.g., number of connection failures per minute). In a related implementation, the count of handover or connection failures includes a count of normal handovers, a count of handovers that are too early, a count of handovers that are too late, and a count of handovers to a wrong cell. In another example implementation, the performance metric includes signaling load per unit time.

The serving access point 610 may include a handover policy optimizing component 616 for optimizing a handover policy for handing over to the neighboring cell based at least in part on the performance metric. For example, the handover policy optimizing component 616 may attempt to adjust handover parameters for the handover policy to reduce the number of connection failures per minute to under a threshold. In another example, the handover policy optimizing component 616 may attempt to adjust handover parameters for the handover policy to keep the signaling load per minute to under a threshold. In yet another example, the handover policy optimizing component 616 may attempt to adjust handover parameters to minimalize the signaling load per minute for a given number of allowed failures per minute.

The serving access point 610 may include a handover policy application component 618 for applying the optimized handover policy to access terminals served by the serving access point 610.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

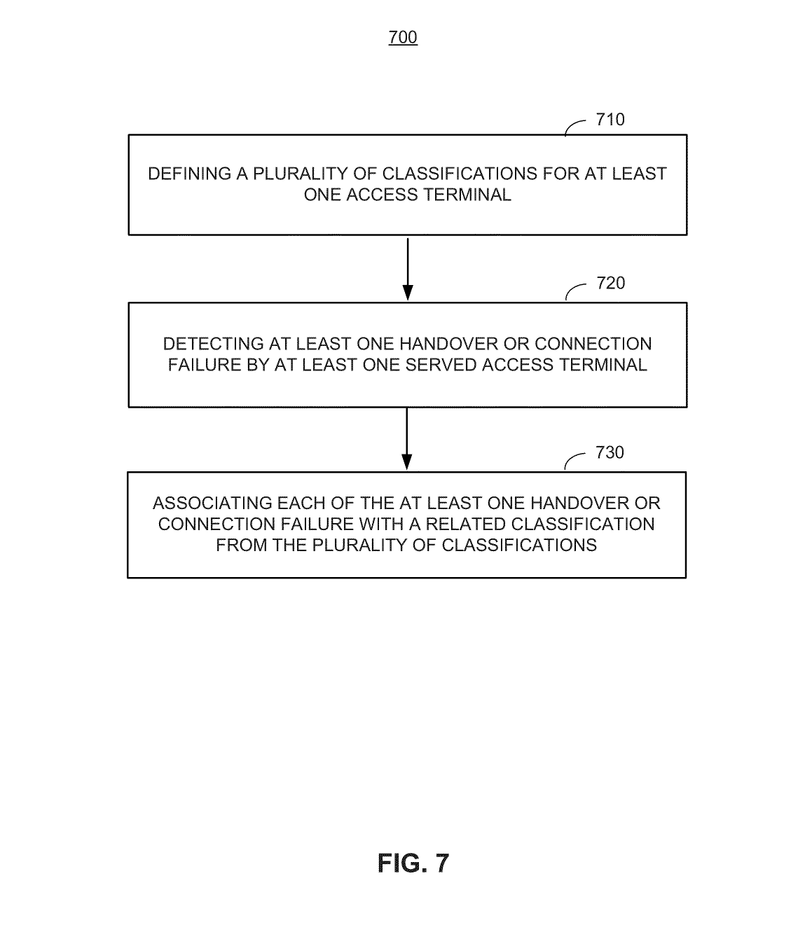

In accordance with one or more aspects of the implementations described herein, with reference to FIG. 7, there is shown an example methodology 700 for optimizing mobility robustness. The method may be operable by a network entity, such as, for example, the serving access point 310, shown in FIG. 3, or the like.

The method 700 may involve, at 710, defining a plurality of classifications for at least one access terminal. For example, the classification defining component 414 of the serving access point 410 may define a number of classifications based on mobility, route, past serving cells, or location of the access terminal 430, as shown in FIG. 4.

The method 700 may involve, at 720, detecting at least one handover or connection failure by at least one served access terminal. For example, the detection component 412 of the access point 410 may detect a handover or a connection failure by the access terminal 430, as shown in FIG. 4.

The method 700 may involve, at 730, associating each of the at least one handover or connection failure with a related classification from the plurality of classifications. For example, the classification association component 416 of the serving access point 410 may categorize each detected handover or connection failure by the access terminal 430 into a related classification, as shown in FIG. 4.

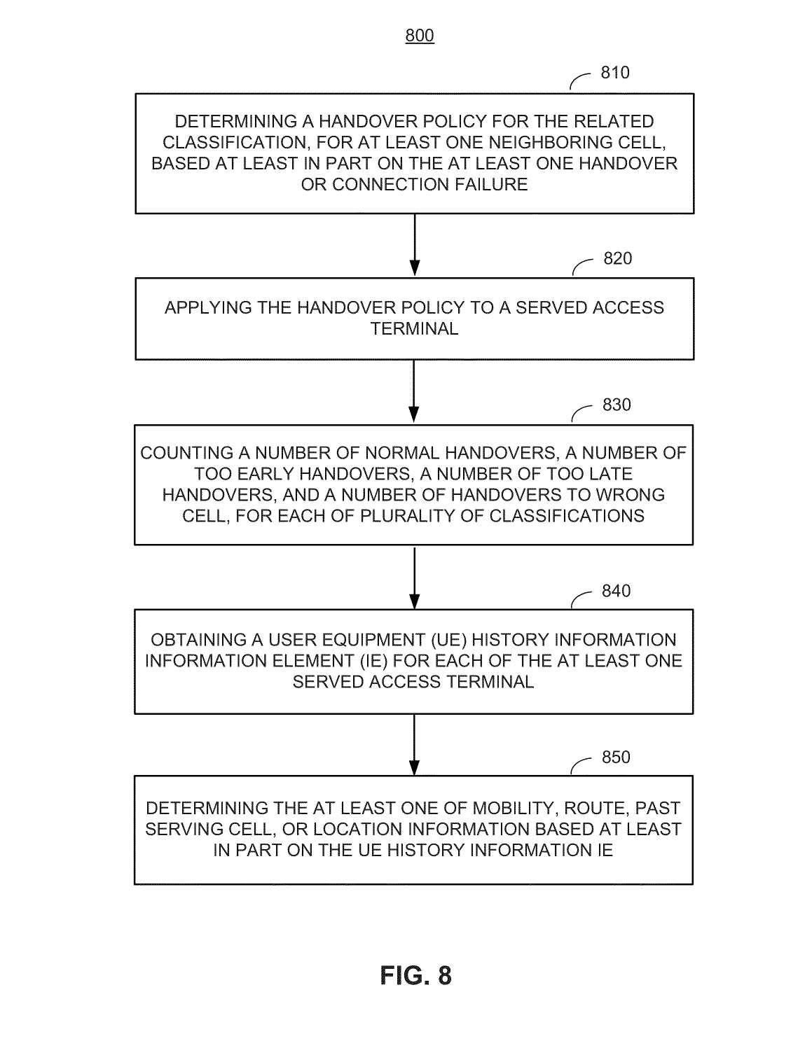

FIG. 8 illustrates further optional operations or aspects of the method 700 described above with reference to FIG. 7. The method 700 may optionally involve, at 810, determining a handover policy for the related classification, for at least one neighboring cell, based at least in part on the at least one handover or connection failure. For example, the handover policy determination component 418 of the serving access point 410 may determine a handover policy with handover parameters that results in faster handovers for a related classification for fast moving UEs, as shown in FIG. 4.

The method 700 may optionally involve, at 820, applying the handover policy to a served access terminal. For example, a determined handover policy with handover parameters that results in slower handovers may be applied to a served access terminal 430 that is ping-ponging between cells, as indicated by at least one cell being re-visited in a given number of handovers.

The method 700 may optionally involve, at 830, counting a number of normal handovers, a number of too early handovers, a number of too late handovers, and a number of handovers to wrong cell, for each of plurality of classifications.

The method 700 may optionally involve, at 840, obtaining a UE history information IE for each of the at least one served access terminal.

The method 700 may optionally involve, at 850, determining the at least one of mobility, route, past serving cell, or location information based at least in part on the UE history information IE. For example, the UE history IE may be used for defining or associating a handover or connection failure with at least one of the plurality of classifications.

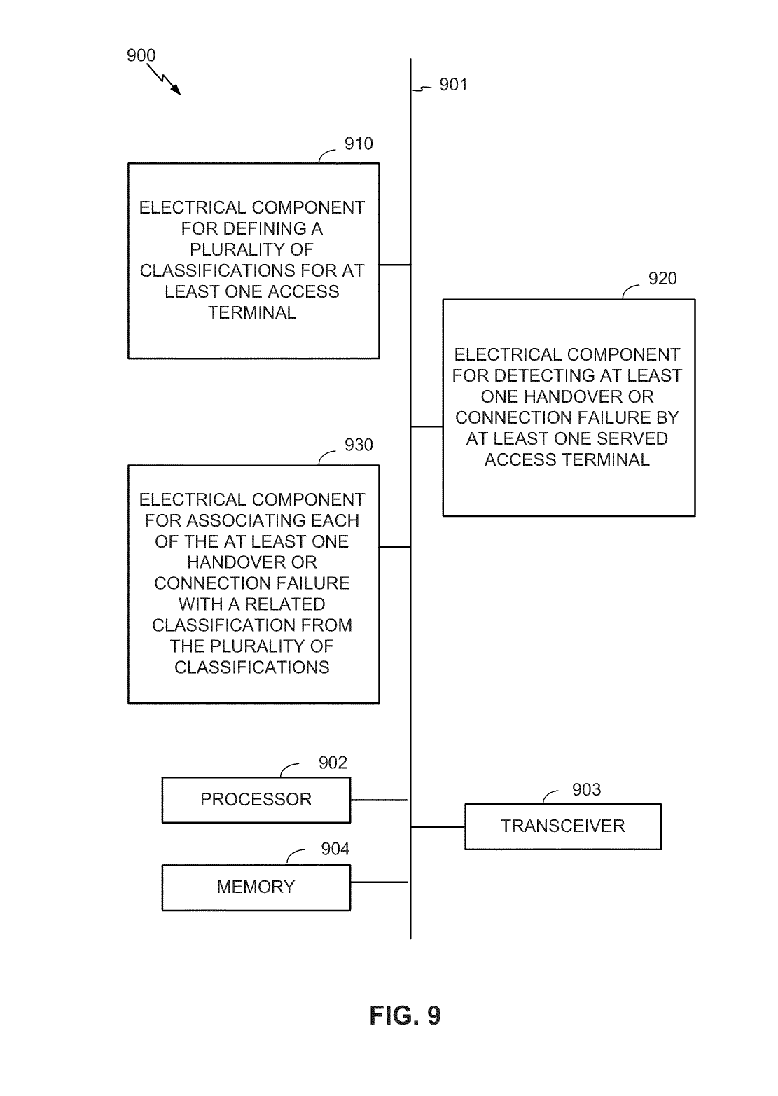

FIG. 9 shows an implementation of an apparatus in accordance with the methodology of FIG. 7. The exemplary apparatus 900 may be configured as a mobile computing device or as a processor or similar device/component for use within. In one example, the apparatus 900 may include functional blocks that can represent functions implemented by a processor, software, or combination thereof (e.g., firmware). In another example, the apparatus 900 may be a system on a chip (SoC) or similar integrated circuit (IC).

In one implementation, apparatus 900 may include an electrical component or module 910. The component 910 may be, or may include, means for defining a plurality of classifications for at least one access terminal. The component 910 may include, for example, a processor coupled to a memory, the memory storing program instructions for defining the plurality of classifications and storing the classifications in the memory.

The apparatus 900 may include an electrical component 920. The component 920 may be, or may include, a means for detecting at least one handover or connection failure by at least one served access terminal. The means may include, for example, an algorithm executable by the processor, the algorithm including operations for detecting a served access terminal leaving service of an access point due to a handover or a connection failure.

The apparatus 900 may include an electrical component 930. The component 930 may be, or may include, a means for associating each of the at least one handover or connection failure with a related classification from the plurality of classifications. The means may include, for example, an algorithm executable by the processor, the algorithm including operations for associating each handover or connection failure with a classification stored in memory.

In further related aspects, the apparatus 900 may optionally include a processor component 902. The processor 902 may be in operative communication with the components 910-930 via a bus 901 or similar communication coupling. The processor 902 may effect initiation and scheduling of the processes or functions performed by electrical components 910-930.

In yet further related aspects, the apparatus 900 may include a radio transceiver component 903. A standalone receiver and/or standalone transmitter may be used in lieu of or in conjunction with the transceiver 903. The apparatus 900 may optionally include a component for storing information, such as, for example, a memory device/component 904. The computer readable medium or the memory component 904 may be operatively coupled to the other components of the apparatus 900 via the bus 901 or the like. The memory component 904 may be adapted to store computer readable instructions and data for affecting the processes and behavior of the components 910-930, and subcomponents thereof, or the processor 902, or the methods disclosed herein. The memory component 904 may retain instructions for executing functions associated with the components 910-930. While shown as being external to the memory 904, it is to be understood that the components 910-930 can exist within the memory 904. It is further noted that the components in FIG. 9 may comprise processors, electronic devices, hardware devices, electronic sub-components, logical circuits, memories, software codes, firmware codes, or the like.

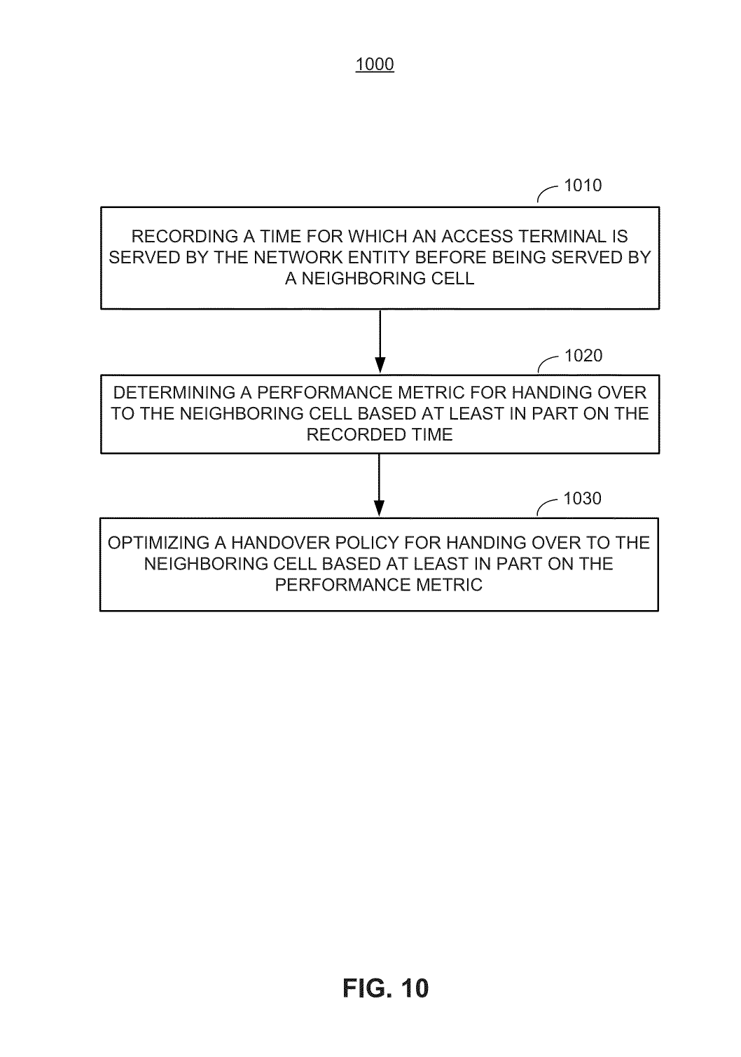

In accordance with one or more aspects of the implementations described herein, with reference to FIG. 10, there is shown an example methodology for improving handover performance. The method may be operable, such as, for example, by the serving access point, shown in FIG. 3, or the like.

For example, the method 1000 may involve, at 1010, recording a time for which an access terminal is served by the network entity before being served by a neighboring cell. For example, the network entity may be the serving access point 610 and the neighboring cell may be served by the neighboring access point 620, shown in FIG. 6. In a related aspect, the time recording component 612 of the serving access point 610 may record a time for which the access terminal 630 is served by the serving access point 610 before leaving for the neighboring access point 620.

The method 1000 may involve, at 1020, determining a performance metric for handing over to the neighboring cell based at least in part on the recorded time. For example, the performance metric determining component 616 of the serving access point 610 may use the recorded time to determine the performance metric, as shown in FIG. 6.

The method 1000 may involve, at 1030, optimizing a handover policy for handing over to the neighboring cell based at least in part on the performance metric. For example, the handover policy optimizing component 616 of the serving access point may adjust the handover policy in order to obtain a desired performance metric, as shown in FIG. 6.

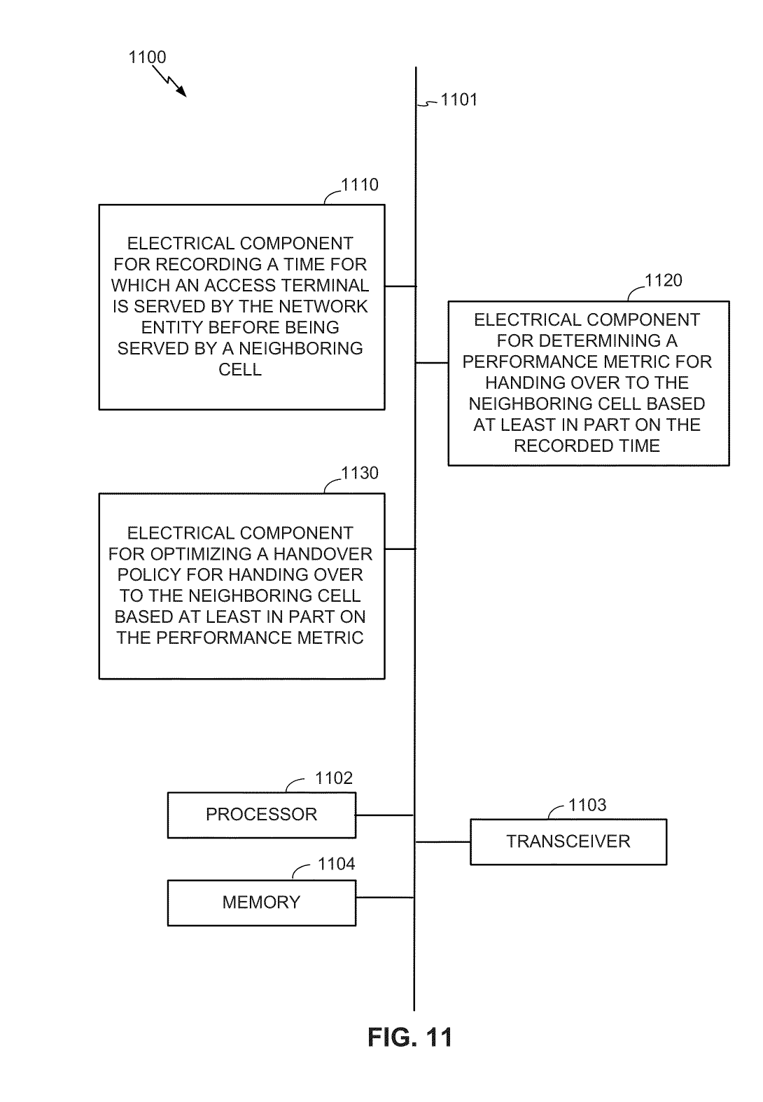

FIG. 11 shows an implementation of an apparatus in accordance with the methodology of FIG. 10. In one implementation, apparatus 1100 may include an electrical component or module 1110 for recording a time for which an access terminal is served by the network entity before being served by a neighboring cell. The component 1110 may include, for example, a processor coupled to a memory, the memory storing program instructions for recording time in the memory.

The apparatus 1100 may include an electrical component 1120. The component 1100 may be, or may include, a means for determining a performance metric for handing over to the neighboring cell based at least in part on the recorded time. The means may include, for example, an algorithm executable by the processor, the algorithm including operations for determining the performance metric.

The apparatus 1100 may include an electrical component 1130. The component 1130 may be, or may include, means for optimizing a handover policy for handing over to the neighboring cell based at least in part on the performance metric. The means for may include, for example, an algorithm executable by the processor, the algorithm may include operations for optimizing the handover policy.

For the sake of conciseness, the rest of the details regarding apparatus 1100 are not further elaborated on; however, it is to be understood that the remaining features and aspects of the apparatus 1100 are substantially similar to those described above with respect to apparatus 900 of FIG. 9.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm operations described in connection with the disclosure herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and other non-transitory media. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where “disks” usually refer to media where data is encoded magnetically, while “discs” refer to media where data is encoded optically. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method of wireless communication by a network entity, comprising:
defining a plurality of classifications for at least one access terminal;
detecting at least one handover or connection failure by at least one served access terminal; and
associating each of the at least one handover or connection failure with a related classification from the plurality of classifications.

2. The method of claim 1, further comprising determining a handover policy for the related classification, for at least one neighboring cell, based at least in part on the at least one handover or connection failure.

3. The method of claim 2, further comprising applying the handover policy to a served access terminal.

4. The method of claim 3, wherein applying the handover policy comprises sending a message to the served access terminal.

5. The method of claim 2, wherein determining the handover policy comprises determining a set of handover parameters based at least in part on the at least one handover or connection failure.

6. The method of claim 5, wherein the set of handover parameters comprises a parameter for comparing the serving cell signal quality with a neighboring cell signal quality.

7. The method of claim 5, wherein the set of handover parameters comprises at least one of a hysteresis parameter, a time-to-trigger (TTT) parameter, or a filter coefficient.

8. The method of claim 5, wherein the set of handover parameters comprises at least one of an event offset parameter, a cell individual offset (CIO) parameter, a reporting range parameter, or a frequency offset parameter.

9. The method of claim 1, wherein the plurality of classifications is based at least in part on at least one of mobility, route, or past serving cells information of the at least one access terminal.

10. The method of claim 9, further comprising:
obtaining a user equipment (UE) history information element (IE) for each of the at least one served access terminal; and
determining the at least one of mobility, route, past serving cell, or location information based at least in part on the UE history information IE.

11. The method of claim 10, wherein the UE History Information IE comprises at least one of a record of identities of past serving cells, a record of time spent on past serving cells, or a handover cause value.

12. The method of claim 1, wherein the plurality of classifications is based at least in part on at least one of location information, path loss information, or received signal quality of the at least one access terminal

13. The method of claim 1, wherein detecting each of the at least one handover or connection failure comprises identifying a handover or connection failure type, in response to a served access terminal disconnecting from the network entity, wherein the handover or connection failure type indicates one of a normal handover, a too early handover, a too late handover; or a handover to wrong cell.

14. The method of claim 13, further comprising counting a number of normal handovers, a number of too early handovers, a number of too late handovers, and a number of handovers to wrong cell, for each of plurality of classifications.

15. The method of claim 1, wherein the network entity comprises a small cell access point.

16. A wireless communication apparatus, comprising:
at least one processor configured to:
define a plurality of classifications for at least one access terminal; and
detect at least one handover or connection failure by at least one served access terminal;
associate each of the at least one handover or connection failure with a related classification from the plurality of classifications; and
a memory coupled to the at least one processor for storing data.

17. A computer program product, comprising:
non-transitory computer-readable medium comprising codes for causing a computer to:
define a plurality of classifications for at least one access terminal;
detect at least one handover or connection failure by at least one served access terminal; and
associate each of the at least one handover or connection failure with a related classification from the plurality of classifications.

18. A method of wireless communication by a network entity, comprising:
recording a time for which an access terminal is served by the network entity before being served by a neighboring cell;
determining a performance metric for handing over to the neighboring cell based at least in part on the recorded time; and
optimizing a handover policy for handing over to the neighboring cell based at least in part on the performance metric.

19. The method of claim 18, further comprising applying the handover policy to at least one served access terminal.

20. The method of claim 18, wherein the handover policy comprises a set of handover parameters for handing over to the neighboring cell.

21. The method of claim 18, wherein the performance metric is indicative of signaling load per unit time.

22. The method of claim 18, wherein the performance metric comprises a count of handover or connection failures per unit time.

23. The method of claim 22, wherein the count of handover or connection failures comprise a count of normal handovers, a count of too early handovers, a count of too late handovers, and a count of handovers to wrong cell.
